(19) United States
(12) Patent Application Publication
(10) Pub. No.: US 2019/0332975 A1
(43) Pub. Date: Oct. 31, 2019

(54) DYNAMIC SEGMENT ACCESS OPTIMIZATION

(71) Applicant: JetSmarter Inc., Fort Lauderdale, FL (US)

(72) Inventors: Olga Oleyarsh, Fort Lauderdale, FL (US); Sergey Petrossov, Fort Lauderdale, FL (US)

(21) Appl. No.: 15/966,625

(22) Filed: Apr. 30, 2018

(51) Int. Cl. G06Q 10/02; G06Q 50/30

(52) U.S. Cl. CPC G06Q 10/02; G06Q 50/30

(57) ABSTRACT

Methods, systems, and apparatus, including computer programs encoded on a computer storage medium, for dynamic segment access optimization. Access to segments can be dynamically optimized by adjusting the existing required amount for remaining spots on an existing segment based on an amount of time remaining until the departure time for the specific segment, first segment capacity for the specific segment, and second segment capacity for matching segments. Multiple different required amounts are generated for the specific segment based on a set of tier factors for multiple different tiers that are applied to the adjusted existing required amount. In response to detecting interaction with a native application, a given tier of a client that performed the interaction is determined, and a user interface of the native application is updated to include a specific required amount that was generated based on the tier factor for the given tier of the client.

### BACKGROUND

This specification relates to optimizing client-initiated segment creation.

Historically, options for traveling between an origin and a destination have been limited to commercial public options in which individual spots (e.g., seats) are acquired by anyone and private options in which all spots in an aircraft or other mode of transport are acquired together by an individual.

### SUMMARY

In general, one innovative aspect of the subject matter described in this specification can be embodied in methods that include the actions of identifying, for each specific segment among a plurality of different segments, a set of segment attributes that include a route of the specific segment and a departure time for the specific segment; for each specific segment among the plurality of different segments: obtaining, from a data storage unit, capacity data including a first segment capacity specifying how many spots remain on the specific segment and a second segment capacity specifying how many spots remain on matching segments that differ from the specific segment; obtaining, from the data storage unit, an existing required amount for the spots that remain on the specific segment; determining, by a spot assessment apparatus, an amount of time remaining until the departure time for the specific segment; adjusting, by the spot assessment apparatus, the existing required amount for the spots that remain on the specific segment based on the amount of time remaining until the departure time for the specific segment, first segment capacity for the specific segment, and the second segment capacity for the matching segments; and generating multiple different required amounts for the specific segment based on the adjusted existing required amount and a set of tier factors for multiple different tiers; detecting interaction with a native application that corresponds to a request for information about a given specific segment among the plurality of different segments: determining a given tier of a client that performed the interaction; and updating a user interface of the native application to include a specific required amount that was generated based on the tier factor for the given tier of the client. Other embodiments of this aspect include corresponding systems, apparatus, and computer programs configured to perform actions of these methods, encoded on computer storage devices.

These and other embodiments can each optionally include one or more of the following features. Methods can include detecting interaction with a spot claim element that is presented in conjunction with the specific required amount by the native application that is executed at a device of the client; in response to detecting the interaction with the spot claim element presented in conjunction with the specific required amount: assigning a spot on the given specific segment to the client; removing the spot on the given specific segment from the first segment capacity for the given specific segment. Methods can include updating the specific required amount for any available spots remaining on the given specific segment after removing the spot on the given specific segment from the first segment capacity.

Adjusting the existing required amount for the available spots that remain on the specific segment further can include adjusting the existing required amount based on a list factor corresponding to how many clients have interacted with a segment list element presented for the specific segment in the native application.

Generating multiple different required amounts for the specific segment can include generating, for all of the multiple different tiers, a required amount of zero for a first available spot that is claimable by clients on the specific segment. Generating multiple different required amounts for the specific segment can include generating a non-zero required amount for one or more additional spots that are claimable by clients on the specific segment.

Generating multiple different required amounts for the specific segment further can include generating one or more multi-spot required amounts that apply when a single client claims multiple spots on the specific segment.

Generating multiple different required amounts for the specific segment further can include generating a sub-capacity required amount based on how many of the available spots on the specific segment are required to remain unclaimed at departure.

The subject matter described and claimed in this document can provide one or more of the following advantages. Various different clients are enabled to access available spots in real-time. The spots can be accessed by the clients at any time utilizing a client side application (e.g., a native application executing at a client device). The details of requirements to access many different available spots on many different segments are continually updated so that the client is provided the most up to date information about the available spots, thereby enabling the real-time access to the available spots. Requirements (e.g. an amount required to be submitted) for access to available spots can be dynamically updated in real-time as various factors change. The requirements for accessing available spots can be adjusted using a multidimensional matrix that balances various different factors that affect the amount required to be submitted to claim an available spot. As such, one dimension of data in the matrix can be enhanced based on other dimensions of data in the matrix, and the enhanced data can be used to determine requirements for accessing available spots. An amount required to obtain an available spot can also be adjusted based on predictions of how many spots will become available in the future, thereby accounting for currently existing conditions as well as expected future conditions. Activity of other clients, such as client creation of other segments that include available spots, can be used to adjust the amount required to be submitted to obtain a particular spot on another similar segment (e.g., segments between a same origin and destination). The amount required to be submitted for available spots can be adjusted based on how many spots are being claimed. The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a block diagram of an example environment in which requirements for access to segments are determined.

FIGS. 1B-1E are screen shots of an example application that enables creation of client-initiated segments.

FIG. 2 is a block diagram of an example data flow for optimizing client-initiated segment creation.

FIG. 3 is a block diagram of an example data flow for dynamically optimizing segment access over time.

FIG. 4 is a flow chart of an example process for dynamically optimizing segment access over time.

FIG. 5 is a block diagram of an example computing device.

Like reference numbers and designations in the various drawings indicate like elements.

### DETAILED DESCRIPTION

This document describes methods, systems, devices and computer readable medium that facilitate the determination of requirements for obtaining access to an available spot on a segment. As used throughout this document, a segment refers to a flight between an origin and a destination. As discussed in detail below, the segment can be initiated by a service provider or a client of the service provider (e.g., a member of a service and/or a user of an application that facilitates creation of the segment), and made available to other clients, for example, by way of a native mobile application (or another appropriate interactive environment, such as a web interface). The aircraft used to travel between the origin and destination is typically a non-commercial aircraft (e.g., a private jet). While any appropriate type of aircraft (e.g., a propeller aircraft, a jet aircraft, or a rotorcraft) can be used to complete the segment, the various possible aircraft will be collectively referred to using the term “jet” for brevity.

As discussed in more detail below, the efficient determination of requirements (e.g., a price) for making spots available on various segments over time requires a real-time (or near real-time) interaction between the client that is claiming an available spot on a segment and the automated computing system that is enabling the client to claim an available spot on the segment. One of the aspects that is required to enable a client to claim an available spot at any time by way of a client-side application is the ability to continuously determine and/or update the appropriate amount that the client will be required to submit (e.g., the price the client will pay) to claim an available spot (e.g., seat) on a particular segment. More specifically, in order to allow clients to claim spots on demand, the amount required to be submitted (“required amount”) for each available spot must be kept current so that when the client accesses the client-side application the required amount for each available spot will reflect the most recent data available. The amount required to be submitted by the client (also referred to as the “required amount”) can be, for example, a monetary price or another appropriate measure of value that must be provided in exchange for the creation/completion of the segment.

The determination of the required amount for each available spot among a very large number of available spots depends on a number of continuously/periodically changing factors, which makes it very difficult to determine and/or update in real-time. For example, when the available spots are on a client created segment, the entity determining the required amount (e.g., the service provider that makes the spots available) can differ from the entity that will be supplying the jet (e.g., the jet operators) for the segment, which means that jet availability and/or cost will be subject to third party (e.g., operator) input at some time after the segment is created (e.g., confirmed) by the client. Additionally, the required amount will vary over time based on various factors such as the number of available spots (e.g., seats) on other segments at the time the spot is being claimed and/or the number of other clients that are requesting segments for the same origin to the same destination. Given these challenges and the real-time interactivity required to facilitate the creation of the segment, a robust technique of determining the amount that is required to obtain available spots on various different segments is needed.

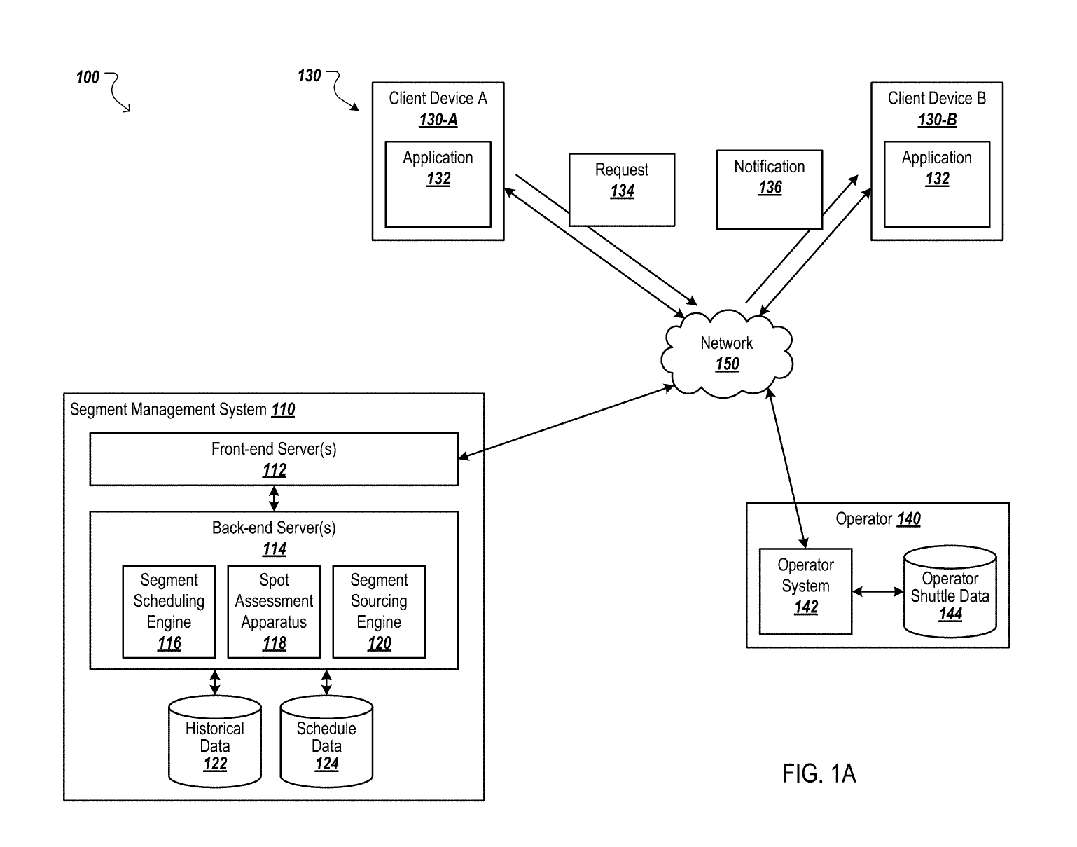

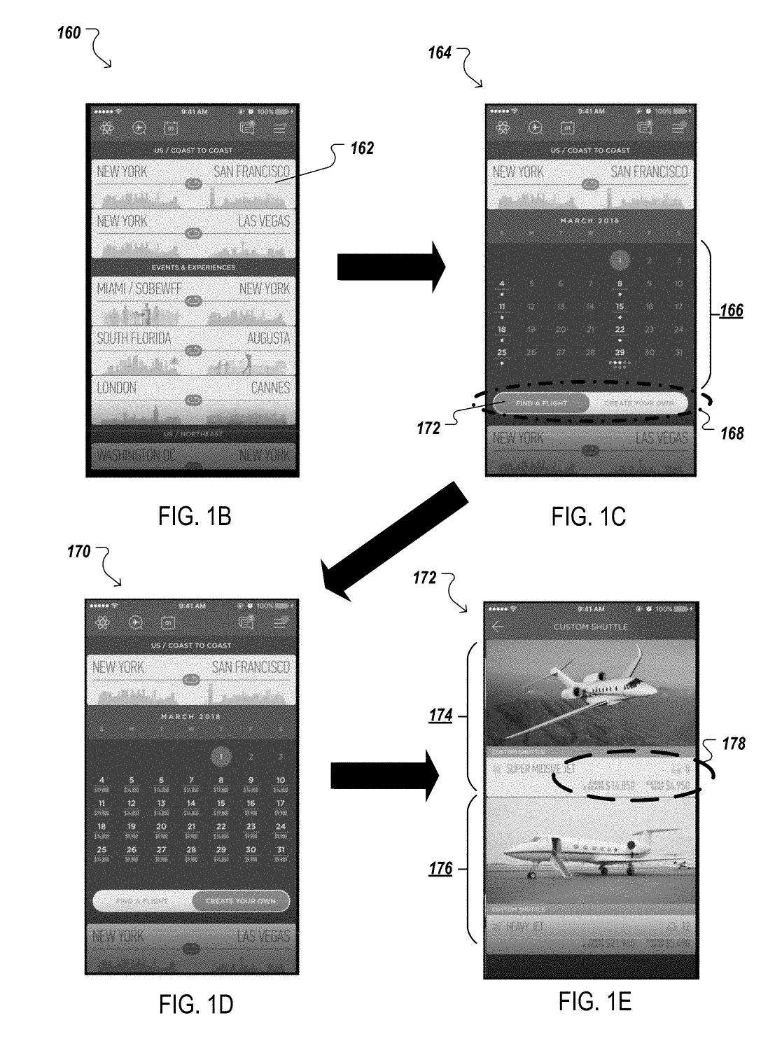

FIG. 1A is a block diagram of an example environment 100 in which a segment management system 110 enables clients to initiate segments. The example environment 100 includes a network 150, such as a local area network (LAN), a wide area network (WAN), the Internet, a mobile network, or a combination thereof. The network 150 connects client devices 130 (e.g., client device A 130-A and client device B 130-B) of clients, the segment management system 110, and operator systems 142 of operators 140. The example environment 100 may include many different client devices 130 and operators 140.

The segment management system 110, which can be operated and maintained by a service provider, allows users to arrange transportation on segments provided by the service provider. The service provider can provide scheduled segments (e.g., flights) between origins and destinations. The service provider can also allow clients (e.g., members of a service provided by the service provider) to initiate segments with custom attributes (e.g., custom departure date, origin, destination, and/or type of jet). For example, a client may want to travel from an origin to a destination on a day in which the scheduled segment(s) from the origin to the destination are full or on a day that no segments are scheduled from the origin to the destination. In this example, the client can initiate a segment from the origin to the destination on the day and/or time that the client wants to travel. A client that initiates a segment is also referred to as a creator.

A client can initiate and manage segments, claim a spot on a segment, manage other travel arrangements with the segment management system 110, and/or perform other appropriate tasks related to the segment management system 110 using a client-side application 132 executed on the client's client device 130. The application 132 can transmit data to, and receive data from, the segment management system 110 over the network 150. The application 132 can be implemented as a native application developed for a particular platform or a particular device, web browser that provides a web interface, or another appropriate type of application. The application 132 can be executed by each of the client devices 130A and 130B.

A client device 130 is an electronic device that is capable of requesting and receiving resources over the network 150. Example client devices 130 include personal computers, mobile communication devices, and other devices that can send and receive data over the network 150. A client device 130 typically includes a user application, such as a web browser or native application, to facilitate the sending and receiving of data over the network 150. The description that follows refers to a client device that interacts with the segment management system using a native application, but the description that follows is equally applicable to interactions with web pages and/or other web-based resources.

The client devices 130A and 130B can each execute the application that provides information about service provider created segments, facilitates creation of client-initiated segments, and provides information about client-initiated segments. As discussed in more detail below, the information about segments (e.g., service provider created segments and/or client-initiated segments) can include a required amount to obtain a spot on the segment. In some implementations, the spot assessment apparatus 118 generates an initial required amount for each spot on a specific segment, and then iteratively updates that initially generated required amount based on various different factors that change over time.

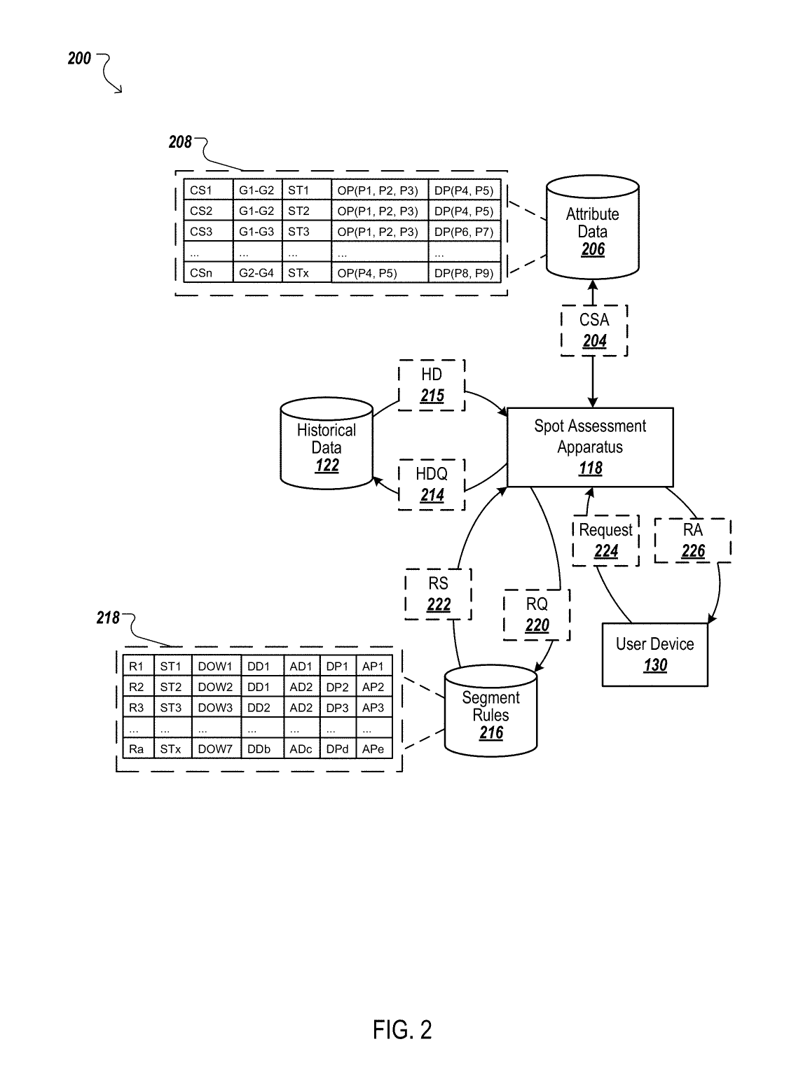

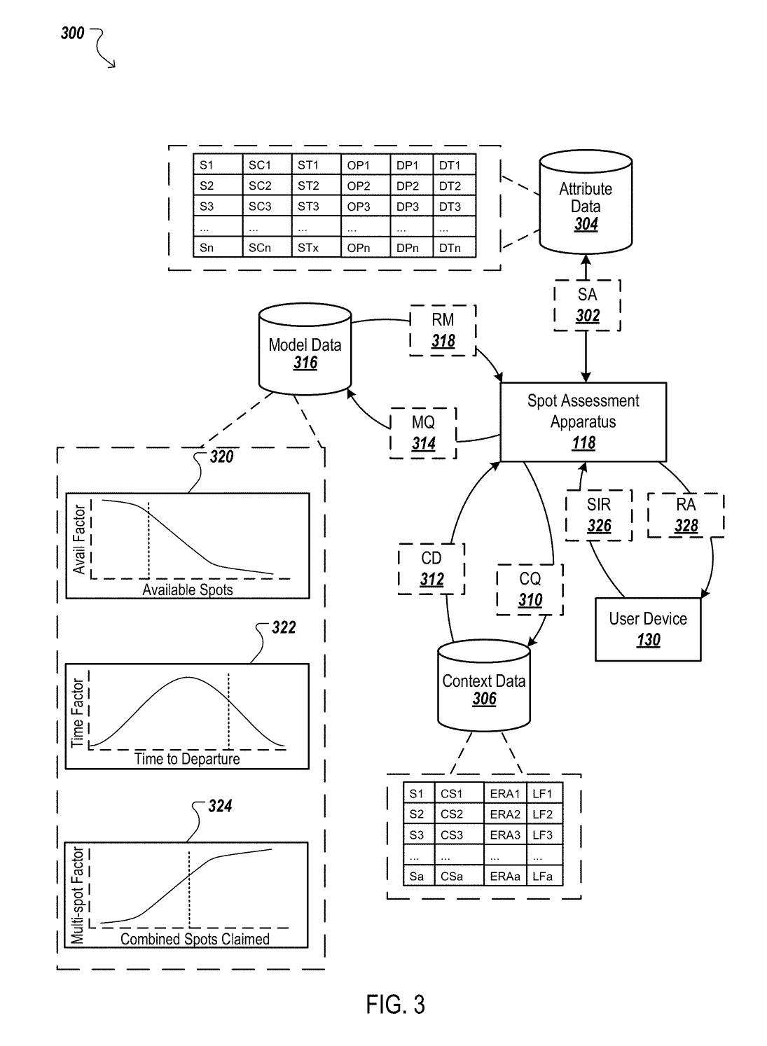

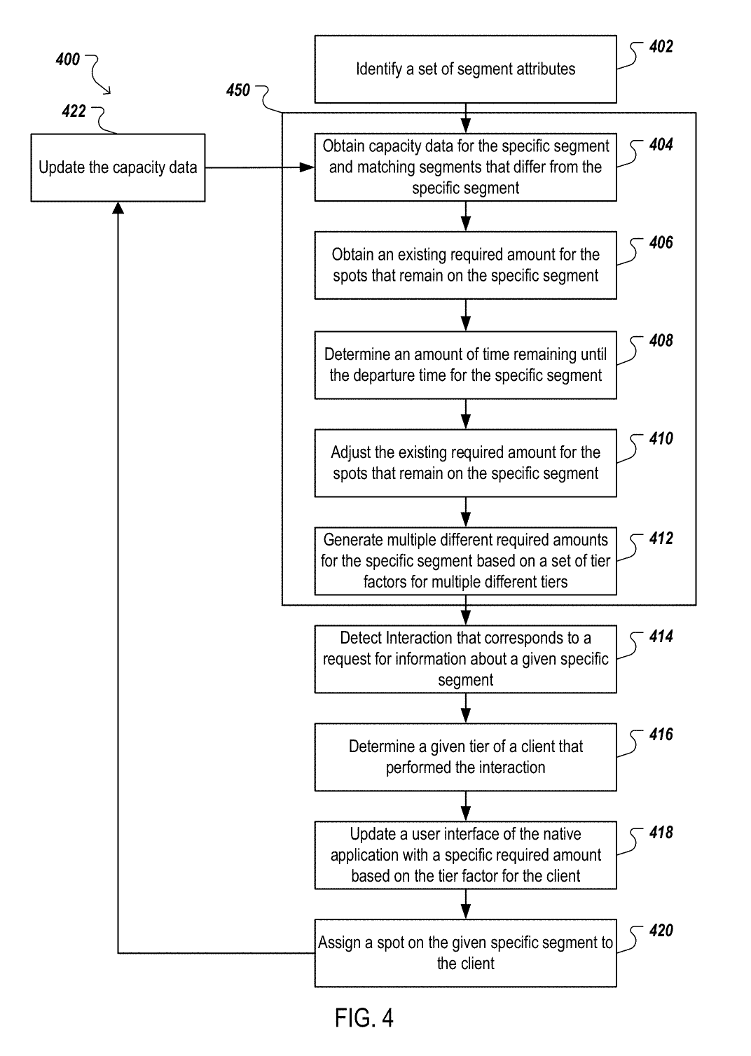

The discussion that follows with reference to FIGS. 1B-1E describes how a client can initiate a client-initiated segment using the application 132, as well as the various segment information that the client can obtain from the application 132. The discussion that references FIG. 2 provides an example of how the spot assessment 118 apparatus generates an initial required amount for spots on a specific segment, and the discussion that references FIGS. 3 and 4 discuss how the spot assessment apparatus 118 can continue to adjust the required amount for spots on the specific segment over time to enable real-time (or near real-time) updates of the required amount for available spots on each available segment.

In some implementations, as shown in FIG. 1B, the application can provide a user interface 160 that enables a client (e.g., application user or service member) to select a route for the segment. For example, the user interface can present pairs of available departure geographic locations (e.g., available origins) and available destination geographic locations (e.g., available destinations) for a segment, and the client can select a pair of geographic locations from the user interface. More specifically, with reference to FIG. 1B, the user interface 160 presents a route 162 that originates in New York and has a destination of San Francisco, as well as other routes between other geographic locations.

The client can interact with a particular route between a pair of available geographic locations presented in the UI 160 to select that route for the segment. For example, the client can interact with (e.g., taps or clicks) the route 162 to select an origin of New York for the segment and a destination of San Francisco for the segment. The interaction with the route 162 in the user interface can be considered (or correspond to) a request for information about available segments between the origin and the destination (i.e., over the route 162) displayed in the user interface, such that detection of the interaction (e.g., by the segment management system 110) can trigger generation of a response that provides the application with additional information about available segments that operate between the origin and destination. For example, the response can include information identifying segments that are operating on various days over a given period of time (e.g., over a next day, week, month, or another appropriate period of time).

In response to selection of the particular route 162, the application can utilize the information included in the response triggered by the request for additional information about available segments to transition to another UI 164 that presents information about existing segments over the selected route 162. For example, as shown in FIG. 1C, the UI 166 can present a calendar interface 166 that shows available dates for already scheduled segments (e.g., service provider created segments and/or client-initiated segments) between the particular geographic locations of the selected route 162. Note that other ways of presenting the available dates can be used (e.g., a list of available dates).

In this example, each dot presented under a calendar date corresponds to an existing segment that is scheduled to operate over the route 162 on the corresponding calendar date. More specifically, March 4^{th} has a single dot presented indicating that a segment is scheduled to operate along the route on that date. In some implementations, each dot can correspond to a single segment or multiple different segments, and the presentation of multiple different dots on a specific date can indicate the relative number of segments that are operating on that date. As such, the dot representation efficiently uses the limited display space to surface more information about available segments on each given day without requiring the client to navigate to various different UI 164 displays to obtain the data.

The UI 164 also enables the client to request more information about an existing segment over the selected route 162 or to create a new segment over the selected route 162. In some implementations, the client can request more information about an existing segment by interacting with the calendar entry corresponding to the date of interest to the client. For example, if the client wants to obtain more information about existing segments on March 4^{th}, the client can tap (or otherwise interact with) the calendar entry for March 4^{th}. The interaction with the calendar entry can trigger the application to generate a request for more information about existing segments operating on the selected day, and to transmit the request to the segment management system 110. In some implementations, the segment management system detects the interaction (e.g., based on the received request for more information about existing segments) and provides information (e.g., such as the required amount for each spot on each segment, an aircraft that will be used on each segment, and other appropriate information about the existing segments. In some implementations, the information provided will be similar to that presented in FIG. 1E, which is discussed below with reference to the client initiated segments.

The calendar interface 164 includes segment creation interface control 168 that enables a client to transition from the user interface 164 that presents already scheduled segments to calendar interface 170, presented in FIG. 1D, which provides the client with information about creating a client-initiated segment over the selected route 162. A client can transition between the calendar interface 164 to the calendar interface 170 by interacting with a bar 172 within the segment creation interface control 168, which triggers the bar 172 to transition from one side to the other, and transitions the client application between the calendar interface 164 and the calendar interface 170 of FIG. 1D.

In some implementations, the calendar interface 170 specifies example amounts that must be submitted (e.g., minimum prices) to confirm a segment on the selected route 162 on different days. For example, the calendar interface 170 shows a minimum required amount of $19,800 for a segment on March 8^{th}, and a minimum required amount of $14,850 for a segment on March 9^{th}. Minimum required amounts are presented for each day of the month on which a client can create a segment. For example, as shown in FIG. 1D, minimum required amounts are presented for March 4^{th}-March 31^{st}, indicating to the client that the client can create a segment on any of these dates. Meanwhile, a minimum required amount is not presented for March 1^{st}-March 3^{rd}, indicating that the client cannot create a segment on those dates.

The amount required to be submitted in this example is expressed in terms of U.S. dollars, but the amount required to be submitted could be expressed in terms of other currencies or items of value, such as internal credits (e.g., renewable tokens or other forms of credits) that are issued by the service provider or some other entity. For example, the service provider may issue clients (e.g., members of a jet service) one or more tokens that can be used (e.g., alone or in combination with a specified amount of money) to secure one or more seats on a segment. When the segment has been completed (e.g., when the subscriber arrives at the destination), the token can be recredited to the subscriber (e.g., added back to the subscriber's account) for use toward another segment.

The segments for which required amounts are presented in the calendar interface are referred to as candidate segments because they are available for creation, but do not exist yet. The presentation of candidate segment information in this manner provides the client with an enhanced user interface that enables the user to quickly obtain access to the minimum required amounts required to create segments on various days without requiring the client to interact with each of the dates on the calendar to obtain the underlying candidate segment information related to that date. This presentation scheme saves the client time, provides direct access to more information, and improves the efficiency of providing relevant information to the client (e.g., by requiring fewer interactions to obtain the information and more efficiently using limited space in the user interface). The manner in which required amounts for candidate segments are determined will be discussed in more detail below.

To obtain more information about segment availability on a specific date, the client can tap or otherwise interact with that specific date in the calendar interface 170. Interaction with a specific date in the calendar interface can trigger the application being executed by the client device to transition from the calendar interface 170 to the segment detail interface 172. For example, if the client interacts with (e.g., taps) the calendar entry for March 8^{th}, the application can present jet information elements 174 and 176, which are also referred to as jet info cards.

In this example, there are two types of jets available for the segment between New York and San Francisco on March 8^{th}, and a respective jet info card is presented for each type of jet. If more than two types of jets are available for the candidate segment, more jet info cards could be presented in the segment detail interface 172 or the application could allow the creator to scroll down to view additional jet info cards.

Continuing with the present example, the jet info card 174 provides information about a candidate segment that can be created using a super midsize jet to travel along the selected route 162. The jet info card includes a representative image of a custom midsize jet (e.g., not an image of the actual jet that would be used for the segment) and segment details 178. The segment details 178 specify a number of spots (e.g., passenger seats) that are on the super midsize jet, the required amount to create the segment using the super midsize jet, and how many spots the client will obtain by submitting the required amount. In this example, the required amount of $14,850 will enable the creator to create the segment using the super midsize jet, and provide the creator with access to three seats, leaving the remaining five seats available for other clients. Of course, the creator could pay to obtain additional ones of the remaining seats, just as other members can, by submitting the “extra seat” amount displayed in the segment details 178 for each additional seat. Similar segment details are provided for the heavy jet in the jet info card 176.

When the creator interacts with either of the jet info cards 174 or 176, the application can proceed to guide the creator through the rest of the process of creating the segment. For example, the application can allow the creator to specify a departure time and/or other details regarding the segment, submit the required amount to create the segment, and confirm the creation of the segment. The segment confirmation is completed, for example, by the segment management system 110, of FIG. 1A.

When a presented jet card includes information about existing segments on which spots are still available, the jet card can specify how many spots remain on the segment, the required amount for each remaining available spot on the segment and/or departure information.

The segment management system 110, in conjunction with the application 132, enables clients to initiate segments as discussed above, claim a spot (e.g., seat) on an existing segment, and/or perform other appropriate tasks. To facilitate these capabilities, the application 132 can transmit data to, and receive data from, the segment management system 110 over the network 150. The application 132 can be implemented as a native application developed for a particular platform or a particular device, web browser that provides a web interface, or another appropriate type of application. As discussed, the application 132 can present and detect user interactions with various interfaces that allow the client to initiate segments, manage segments, and/or claim a spot on segments.

The segment management system 110 includes one or more front-end servers 112 and one or more back-end servers 114. The front-end servers 112 can transmit data to, and receive data from, client devices 130, e.g., client device A 130-A and client device B 130-B, and operator systems 142 of operators 140 over the network 150. For example, the front-end servers 112 can provide, to the application 132 of a client's client device 130, interfaces or data for presentation with the interfaces. The front-end servers 112 can also receive data specifying user interactions with the interfaces of the application 130, such as attributes of a segment initiated by the client. As described in more detail below, the front-end servers 112 can update the interfaces, provide new interfaces, and/or update the data presented by the interfaces based on user interactions with the application 132.

The front-end servers 112 can also communicate with the back-end servers 114. For example, the front-end servers 112 can identify data that is to be processed by the back-end servers 114, e.g., data specifying attributes of a candidate segment, and provide the identified data to the back-end servers 114. The front-end servers 112 can also receive, from the back-end servers 114, data for a particular client and transmit the data to the client device 130 of the particular client over the network 150.

The back-end servers 114 include a segment scheduling engine 116, a spot assessment apparatus 118, and a segment sourcing engine 120. The segment scheduling engine 116 manages the creation, confirmation, and/or cancellation of segments including segments. The segment scheduling engine 116 can receive data specifying attributes of a segment initiated by a client and create the segment within the segment management system 110. For example, a client that uses client device A 130-A can interact with the application 132 to initiate a segment and specify attributes of the segment. The attributes can include a departure geographic identifier (e.g., an origin city or airport code), a destination geographic identifier (e.g., a destination city or airport code), a departure date (which can include a date and/or time) at which the segment will depart from the origin, a type of j et (e.g., light, midsize, heavy, propeller, rotorcraft, etc.), and/or other appropriate attributes. As used herein, the term engine refers to a data processing apparatus that performs a set of tasks.

The application 132 can generate a segment request 134 and cause the client device A 130-A to transmit the segment request 134 to the segment management system 110 over the network 150. The segment request 134 can include one or more of the client-specified attributes. In some implementations, the segment request 134 can include all of the attributes. For example, the application 132 can cause the client device A 130-A to transmit the segment request 134 after all of the appropriate attributes have been obtained from the client. As discussed above, the application 132 can prompt the client for the attributes using multiple interfaces.

In some implementations, the segment request 134 includes only a portion of the attributes (e.g., less than all of the attributes required by the segment service provider). For example, the segment scheduling engine 116 can cause the application 132 to prompt the client for additional attributes or other information based on initial attributes received in the segment request 134. In a particular example, the segment request 134 can include the departure geographic identifier, destination geographic identifier, and departure date. The segment scheduling engine 116 can receive these attributes, identify what types of jets are available for travel from the origin to the destination, and provide data specifying the available types of jets to the client device A 130-A for presentation by the application 132 to the client. The client can then select from the available types of jets and the application 132 can cause the client device A to transmit data specifying the selected type of jet to the segment management system 110.

The segment scheduling engine 116 can receive the data and create the appropriate segment within the segment management system 110 based on the data and the attributes received from the client device A 130-A. The segment scheduling engine 116 can also store the data for the created segment in a schedule data storage unit 124. The schedule data storage unit 124 can include one or more databases (or other appropriate data storage structures) stored in one or more non-transitory data storage media (e.g., hard drive(s), flash memory, etc.).

The segment data storage unit 124 can store data for each segment that is provided by the segment service provider. For example, the segment data storage unit 124 can store data for each scheduled and each client-initiated segment. The data for each segment can include the departure geographic identifier for the segment, the destination geographic identifier for the segment, the departure date for the segment, the type of j et and/or an identifier of the actual jet being used for the segment, an identifier for each client that has claimed a spot on the segment, and/or other appropriate segment data. The data for each segment can also include data specifying whether the segment is a client-initiated segment or a service provider scheduled segment.

The segment scheduling engine 116 can notify other clients of the created segment. In some implementations, clients can view the various segments from an origin to a destination. For example, the application 132 can present segments from an origin to a destination using a calendar interface (e.g., the calendar interface 164 of FIG. 1C). The calendar interface can include, for each date, zero or more segment indicators for each segment scheduled (or conditional) to travel from the origin to the destination on that date. For example, each segment indicator may be a dot under the date in the calendar, as shown in FIG. 1C. In this example, after the segment is created, a segment indicator will be presented under the departure date for the segment to represent the created segment. If a different client is viewing the calendar interface for flights from the same origin and to the same destination as the created segment, the client can see the dot for the created segment and interact with the dot or the date (e.g., by selecting the dot or the date) to view more information about the created segment and/or claim a spot on the created segment.

In some implementations, the segment scheduling engine 116 notifies clients using push segment notifications 136 (and/or through client navigation of the application, as discussed in more detail below). For example, the segment scheduling engine 116 may send messages (e.g., within the application 132, via text messaging, and/or via e-mail) to the clients to notify the clients of the created segment. The messages can include a link to an application page within the application 132 (or to a web page in a web interface) to claim a spot on the segment. In some implementations, the segment scheduling engine 116 sends the notifications 136 to clients that are likely to be interested in the created segment, e.g., based on previous segments on which the clients were passengers, preferred location information specified by the clients (e.g., in a client profile), and/or the geographic (e.g., GPS) location of the clients.

Data regarding previous segments that were created by clients and/or on which clients were passengers is stored in a historical data storage unit 122, e.g., as part of data regarding each previously operated segment. In some implementations, the stored data can include one or more of an identifier of the client that created the segment, the type of aircraft selected for the created segment, an amount submitted by the client to create the segment or obtain a spot on a segment, a departure date and/or time for the segment, the origin and destination of the segment, a number of available seats remaining on the created segment when created and/or at departure time, the operator that will provide the selected aircraft, and/or other information.

The segment management system 110 also includes a spot assessment apparatus 118. The spot assessment apparatus 118 can determine the required amount that must be submitted by a creator to create each candidate segment and/or the amount that clients are required to submit for each spot that remains available on a segment after creation. The required amount that must be submitted by the creator and/or the amount required for each remaining spot can be based on various factors, such as the type of jet, the departure and destination geographic identifiers, the departure date, the duration of time between the time the segment is initiated and the departure date, the type of segment (e.g., conditional or confirmed), data stored in the historical data storage unit 122, and/or other appropriate factors.

As discussed above, the application 132 can present the required amount to create a segment and the amount for each remaining spot of an already created segment at the interfaces that enable the clients to initiate a segment and/or to claim a spot on a segment. For example, the application 132 can request current amounts for a candidate segment from the spot assessment apparatus 118 in response to a client interacting with the bar 172 within the segment creation interface control 168 of FIG. 1C. Similarly, interaction with a date of the calendar interface presented in FIG. 1C can initiate a request for information about existing segments. In another example, the application 132 can request the information before the client selection, e.g., when the client opens the application 132, when the client selects the same origin and destination as the candidate segment or an existing segment, or periodically. In this way, the latency in presenting the information can be reduced. In some implementations, the amount of data cached at the client-device can be reduced by providing the data when it is needed to populate the user interface.

The segment management system 110 also includes a segment sourcing engine 120. The segment sourcing engine 120 can interact with the operator systems 142 of the operators 140 to select jets for the segments and obtain information about the jets (e.g., number of spots on the jet, costs for particular segments, range, etc.). For example, when the segment scheduling engine 116 creates a segment (e.g., a confirmed segment), the segment sourcing engine 120 can interact with the operator systems 142 to identify a jet of the same type as the created segment that can be used for the segment. For example, the segment sourcing engine 120 can submit a request to each operator system 142 for a jet of the type of the created segment.

In response to receiving a request, the operator systems 142 can obtain data regarding available jets from their respective operator segment data storage units 144 and provide, to the segment sourcing engine 120 the information about any available jets that the operator 140 would be willing to operate for the created segment (e.g., number of spots on the jet, rates for particular segments, range, etc.). If multiple operators 140 have an available jet, the segment sourcing engine 120 can select a jet for the created segment based on the information provided by the operator systems 142.

In some implementations, the front-end servers 112 of the segment management system 110 communicate with the operators systems using application programming interfaces (APIs). The use of the APIs require computational power to communicate data. To reduce the amount of computational power used by the APIs, the segment management system 110 may identify a subset (e.g., less than all) of operators 140 for a particular segment and provide the request to only the operators in the subset. The segment management system 110 can identify the subset of operators based on the departure geographic identifier (e.g., identify operators that operate jets in the geographic area from which the segment will depart), previous segments provided by the operators (e.g., previously provided a jet for the same origin and destination), types of jets that the operator operates, and/or other appropriate criteria. In some implementations, communications with operators can be carried out using other communications means (e.g., phone). When the segment has been confirmed by the operator, the selected aircraft will be deployed to the origin at an appropriate time so that the selected aircraft will be available for any clients that have obtained spots (e.g., seats) on the created segment.

One of the challenges in offering spots on private jets to individuals is that there are a limited number of available spots, and the service provider cannot overbook segments in the way that commercial airlines can. As such, service providers that offer clients spots on private jets must determine the required amount for each available spot on the jets in a way that balances the need to have clients claim the spots, while not overbooking, and while ensuring that the amount collected for a particular segment will be sufficient to cover the cost of sourcing the jet from an operator. More specifically, the segment management system 110 must continually monitor the remaining seats that are available on various different segments and dynamically adjust the required amounts based on various pieces of information so that the segment management system 110 will improve the chances that all spots on the segments are claimed by clients, while ensuring that the amount submitted by the clients covers the cost of sourcing the jet.

Furthermore, maintaining updated amounts and available spot information is important to ensure that segments are not overbooked, and that clients are able to claim a spot on a segment at one required amount (e.g., one price) after the required amount for spots on that segment have changed and/or after other clients have already claimed the available spots on that segment (e.g., using the application at their respective client devices). For example, if a client attempts to claim a spot that was just claimed by another client or that has a new updated required amount that differs from what was presented to the client, the application can prevent the spot from being claimed and provide the client with new information (e.g., an updated required amount or availability information) rather than allowing the client to claim the spot.

As discussed in more detail below, the required amount (e.g., required price) for each spot is dependent on a number of ever changing factors that must be continually be taken into consideration in order to maximize the likelihood that all of the spots on each segment will be claimed. The amount of data that is required to be considered during these dynamic changes to the required amount for each spot, and the fact that this data is ever changing, prevents a person (or even a team of people) from being able to continually update the required amount that is made available to various clients for countless possible travel routes (e.g., between various combinations of origins and destinations). For example, in the amount of time it would take a person to revise a single required amount for a single travel route and single jet type, the combination of factors considered in making the revision likely would have changed, thereby rendering the human created required amount outdated. Manual computation of the updated per-spot required amount would also prevent the real-time interactivity that is provided by the system described herein. Thus, the use of a computer system to implement the techniques described herein is not simply to improve an existing process, but rather the use of the computer system is required to provide the capabilities described herein.

To facilitate the dynamic updating of required amounts for various different segments, thereby providing dynamic segment access optimization, the backend server 114 includes a spot assessment apparatus 118. As discussed in more detail below, the spot assessment apparatus 118 processes various sets of segment attributes and context data for various different segments to dynamically adjust a per-spot required amount (simply referred to as a “required amount for brevity) for each spot on the various different segments. This required amount is continually (or periodically) updated over time to adjust for changing factors that affect the required amounts so that, at any given point in time, the required amount provided to a client in response to real-time interactions with the application 132 being executed at the client device 130 will up to date and reflect the factors as they exist at that point in time.

FIG. 2 is a block diagram of an example data flow 200 for optimizing client-initiated segment creation. The data flow 200 can begin with the spot assessment apparatus 118 obtaining a set of candidate segment attributes (CSA) 204. The CSA 204 can be obtained, for example, from an attributes data storage unit 206. The attributes data storage unit 206 can include a set of segment attributes for each candidate segment among multiple different candidate segments. For example, as shown in FIG. 2, the attributes data storage unit 206 can store an index of attributes 208 (or set of attributes) that are indexed to one or more possible routes, segment types (e.g., aircraft types), airport combinations, or other dimensions of data. In other words, the attributes data storage unit 206 can store a multi-dimensional index that can be searched based on any of the dimensions of data to obtain information about candidate segments having attributes that match specified search criteria. As used throughout this document, a candidate segment refers to a segment that is not currently scheduled, but can be created by a client.

The set of attributes stored in the attributes data storage unit 206 for each candidate segment can include, for example, a pair of geographic locations (e.g., G1-G2) between which the candidate segment will travel. For example, the notation G1-G2 in FIG. 2 indicates that an origin of the candidate segment CS1 is the geographic location G1 (e.g., a city/state combination) and the destination of CS1 is the geographic location G2. Similarly, the notation G1-G3 indicates that an origin of the candidate segment CS2 is the geographic location G1 and the destination of CS3 is the geographic location G3. Other pairs of geographic locations are similarly stored in the attributes data storage unit 206 for other candidate segments.

The set of attributes stored in the attributes data storage unit 206 can also include a segment type (e.g., ST1, ST2, . . . STn) for each candidate segment. The segment type specifies a type of aircraft that is used for the candidate segment. For example, ST1 may specify that a light jet is being used for a candidate segment, while ST2 may specify that a super midsize jet will be used, and ST3 may specify that a heavy jet will be used. As shown in FIG. 2, the index of attributes 208 indicates that ST1 will be used for CS1, while ST2 will be used for CS2. As such, different segment types are available between G1 and G2.

The set of attributes stored in the attributes data storage unit 206 can also include a set of available ports (e.g., airports) between which the candidate segment will travel. The set of available ports can include multiple different ports for each of the origin geographic location and the destination geographic location, as there are often multiple different airports at each geographic location. For example, the origin port (OP) for CS1 can be any of P1, P2, or P3 and the destination port (DP) for CS1 can be any of P4 or P5. These example attributes are only provided for purposes of illustration, and the attributes data storage unit 206 can certainly include various other attributes.

The spot assessment apparatus 118 obtains historical data 215 about each candidate segment. The historical data 215 can be obtained from the historical data storage unit 122. The historical data storage unit 122 is a data storage device that stores information about segments that have been previously completed. The historical data storage unit 122 can store information such as how many clients traveled on each prior segment (client total), departure and arrival dates for the segment, origin and destination information for the segment, and amounts submitted by the clients to travel on the segment.

The historical data 215 can be stored, for example, in a historical data index. The historical data index can be a multi-dimensional index in which various historical segment information can be obtained by searching any of the various dimensions of historical data. Thus, the spot assessment apparatus 118 can query the historical database can specify query terms corresponding to one or more of the dimensions of data stored in the historical data storage unit 122 to obtain historical information about a specific segment (or set of segments). More specifically, the historical data storage unit 122 can use the set of attributes (e.g., all or less than all of the attributes) to generate a historical data query (“HDQ”) 214 to obtain historical data 215 about the candidate segments. For example, the historical data storage unit 122 can generate a particular historical data query 214 that specifies one or more of the attributes of CS1 and query the historical data storage unit 122 using that historical data query 214. In this example, the historical data query 214 will return a set of historical data 215 for previous segments having attributes matching the set of attributes for the candidate segment CS1. Other queries can similarly be generated and used to obtain other sets of historical data for other candidate segments.

The spot assessment apparatus 118 accesses a segment rules data storage unit 216 to obtain a set of rules (“RS”) 222 for each candidate segment. The segment rules data storage unit 216 is a data storage device that stores rules used to generate and/or update required amounts for different candidate segments. The rules can specify, for example, how to determine a baseline amount for each given candidate segment based on the set of attributes for the given candidate segment and/or the historical data for previous segments that have attributes matching the set of attributes for the given candidate segment. In some implementations, the rules stored in the segment rules data storage unit 216 can be indexed to one or more segment attributes. For example, any of the rules can be indexed to attributes including one or more of a segment type (ST), a departure day of the week (DOW), a departure date (DD), an arrival date (AD), departure port (DP), arrival port (AP), and/or other appropriate attributes of a candidate segment. FIG. 2 includes an example illustration of a rules index 218 in which each rule is indexed to the attributes noted above. Rules can also be indexed to other attributes.

Indexing the rules to various different attributes enables efficient querying of the segment rules data storage unit 216 to obtain a set of rules that are applicable to a particular candidate segment. In some implementations, the spot assessment apparatus 118 can generate a rule query (“RQ”) 220 that specifies a combination of attributes of the particular candidate segment, and can query the segment rules data storage unit 216 to identify the set of rules 222 that are appropriate to apply to the particular candidate segment. For example, assume that the particular candidate segment is a segment between Atlanta and Fort Lauderdale, and the particular candidate segment will depart from Peachtree DeKalb Airport (PDK) in Atlanta, Ga. and arrive at Fort Lauderdale-Hollywood International Airport (FLL) in Fort Lauderdale, Fla. on a Wednesday. In this example, the rule query 220 generated by the spot assessment apparatus 118 can include the attributes of DP=PDK; AP=FLL; DOW=Wed. This rule query 220 will return the set of rules 222 that are indexed to the combination of attributes specified in the query, which can then be used by the spot assessment apparatus 118 to determine the baseline amount for the particular candidate segment.

In some implementations, the set of rules 222 for a particular candidate segment can specify how different ones of the attributes and/or historical data 215 contribute to the baseline amount for the particular candidate segment. For example, a particular rule set (e.g., R1) that is applied to a particular candidate segment (e.g., CS1) can specify that the amount of time between the creation date (e.g., when the segment is created) and the departure date will contribute a given amount to the baseline amount, and that the amount contributed increases as the amount of time between the creation date and the departure date decreases. Similarly, the set of rules 222 can specify different contributions to the baseline amount depending on the day of the week on which the departure date falls. For example, the set of rules 222 may specify that the contribution to the baseline amount for departure dates that fall on Mon-Thur. or Sat differ from the contribution to the baseline amount for departure dates that fall on Fri. or Sun. Similarly, the set of rules 222 can specify a contribution to the baseline based on an amount of time between the time at which the baseline amount is being determined and the date of departure. Generally, the contribution to the baseline amount increases as the amount of time between the time at which the baseline amount is being determined and the date of departure decreases.

In some situations, the different contribution amounts specified by the set of rules 222 can be determined, for example, based on application of the set of rules 222 to the historical data 215 obtained for the candidate segment. For example, the set of rules 222 can specify that the baseline amount be determined based on a combination of the average total amount received for past segments having the same attributes, the average cost of providing the past segments having the same attributes, and/or an average number of empty spots on the past segments having the same attributes. Of course, other historical measures for past segments can also be used to determine the baseline amount.

The creation of a new segment affects an overall availability of spots on segments having the same attributes (e.g., between the same DP and AP). For example, each time a new segment is created additional spots between the DP and AP are made available (assuming that the creator of the segment does not utilize all seats on the segment). As such, the set of rules 222 may specify an amount of contribution to the baseline amount (e.g., increase the baseline amount) for each additional positon (e.g., seat) that will be unoccupied at the time the segment is created (e.g., how many seats will be made available to other clients through creation of the candidate segment). Generally, the contribution amount for each additional spot will rise as the total number of available spots for that particular combination of DP and AP increases. In other words, as the total number of available spots for that particular DP and AP increases, the contribution to the baseline amount that is provided by each additional spot can increase.

The spot assessment apparatus 118 applies the set of rules 222 to the attributes of the candidate segment to determine the baseline amount for the candidate segment. The spot assessment apparatus 118 can determine a separate baseline amount for each different candidate segment that is able to be created by way of the application. The spot assessment apparatus 118 can adjust (and/or update) the baseline amount based on various conditions that may exist on a specific day and/or other factors that are unique to a given candidate segment. For example, the spot assessment apparatus 118 may determine that the historical data 215 indicates that a particular day of the year is a peak day for client segment creation (e.g., there may be increased demand for client-initiated segments on that particular day). In this example, the spot assessment apparatus 118 can apply a surge factor to the baseline amount for candidate segments on that particular day. The surge factor can be applied to the baseline amount, for example, by adding the surge factor to the baseline amount, multiplying the surge factor and the baseline amount, or otherwise increasing the baseline amount using the surge factor.

As noted above, there are a number of factors that change continuously (or at least periodically) over time. As such, the baseline amount (or adjusted baseline amount) that the spot assessment apparatus 118 determines for each candidate segment becomes stale very quickly. For example, each available segment spot (e.g., seat) that is claimed by another client or added by way of client creation of another segment affects the required amount for creation of another segment between the same DP and AP. Additionally, as time passes, the amount of time between the present time and a particular departure date for various candidate segments departing on that departure date decreases, which affects the amount that will be required to create the candidate segments having that departure date. As such, the spot assessment apparatus 118 can continually (or periodically) adjust and/or update the amount required for and/all of the candidate segments over time, and immediately make these adjusted amounts available through the application.

For example, after determining the baseline amount for a given candidate segment, the spot assessment apparatus 118 can access the historical data storage unit 122 and determine whether current factors (e.g., recently stored historical data) affect the baseline amount for the given candidate segment. Some of the current factors that affect the baseline amount for the given candidate segment include a change in a number of available spots on other segments that have one or more of the same attributes (e.g., route and/or date) as the given candidate segment, how many other segments have been created for the same route (e.g., DP to AP), and/or how many available segments having the same route as the candidate segment have expired.

In some implementations, the spot assessment apparatus 118 can adjust the baseline amount and/or a previously determined required amount obtained through a previous adjustment(s) to a baseline amount using one or more adjustment factors. For example, the spot assessment apparatus 118 can use a creator seat factor to adjust a required amount (e.g., a baseline amount or previously determined required amount) for a particular segment route (e.g., DP to AP pair and/or city pair). The creator seat factor can be used, for example, to increase the required amount for the particular candidate segment based on how many seats creation of a new segment will add to an inventory of available seats on that particular segment route. For example, the creator seat factor will generally be lower for a seven seat jet than a fifteen seat jet because creation of a new segment using the seven seat jet will add fewer seats the to the inventory of available seats than creation of a new segment using the fifteen seat jet.

The magnitude of the creator seat factor can also vary based on the current level of available seat inventory on the particular segment route. For example, the creator seat factor can increase as the total number of available seat inventory increases and decrease as the total number of available seat inventory decreases. As such, the creator seat factor can vary over time in proportion (e.g., linearly, logarithmically, or otherwise in proportion) to changes in the current level of available seat inventory. The spot assessment apparatus 118 can mathematically combine the creator seat factor with the current required amount in a variety of ways to adjust the required amount. For example, the creator seat factor can be added to or multiplied with a current required amount (e.g., the required amount just prior to the adjustment) to obtain an adjusted (or updated) required amount.

In some implementations, the spot assessment apparatus 118 can use a time penalty factor to adjust the baseline amount and/or a previously determined required amount obtained through a previous adjustment(s) to a baseline amount. A particular time penalty factor value can be applied, for example, on a per-route basis, on a per-city basis, on a per-region basis, or globally across all segment routes. The magnitude of the time penalty factor can vary over time. For example, the magnitude of the time penalty factor for a particular departure date can increase as the current time (e.g., the day on which the adjustment is being made) and the departure date decreases. In a specific example, assume that the current time is May 3, 2018 and a particular time penalty factor (e.g., for a specific route) for jets departing on May 10^{th} is X. In this example, on May 4^{th}, the particular penalty factor for jets departing on May 10^{th} can increase to X+Y based on amount of time between the current time and May 10^{th} decreasing by a day. In this example, the spot assessment apparatus 118 will use the time penalty factor X to determine the required amount on May 3^{rd}, and the spot assessment apparatus 118 will use the time penalty factor X+Y to determine the required amount on May 4^{th}. The time-based adjustment to the penalty factor can be a linear adjustment, a logarithmic adjustment, a schedule based adjustment, or another adjustment scheme.

In some situations, the service provider may allow for multiple different client levels (also referred to as different client tiers), and the spot assessment apparatus 118 can generate multiple different required amounts for the same segment on a per-client-level basis. Clients may be able to attain different client levels in a variety of ways. For example, clients may be able to attain a higher client level by paying a fee, claiming a minimum number of seats on client-initiated segments over a given time period, referring a specified number of others that become clients, or engaging in some other appropriate activity. The service provider may provide incentives for clients to attain these higher client levels by varying the required amounts for segments based on client level. As such, the spot assessment apparatus 118 can generate multiple different required amounts for the same candidate segment by applying different client level factors. For example, the spot assessment apparatus 118 can generate a different required amount for each different client level by applying the client level factor for that client level to the required amount to create the per-client-level required amounts. Generally, the client level factor for higher client level will result in a lower required amount than the client level factor for a lower client level.

In some implementations, the spot assessment apparatus 118 can temporarily reduce the required amount for a particular segment route using a condition limited reduction factor. For example, when the spot assessment apparatus 118 determines that additional spots on a particular segment route need to be added to the current level of available inventory for that particular route, the spot assessment apparatus 118 can apply the condition limited reduction factor to the required amount existing at the time of the determination to lower the required amount. The condition limited reduction factor is a value that is used to reduce the required amount until a particular condition is met. The condition can be, for example, the creation of a specified number of new client-initiated segments at the reduced required amount, a specified amount of time, the current available seat inventory meeting a specified level, or some other condition. When the particular condition has been met, the spot assessment apparatus 118 can disable the condition limited reduction factor for that particular segment route, and the spot assessment apparatus 118 can return to determining the required amount as discussed above without applying the condition limited reduction factor.

The spot assessment apparatus 118 can receive a segment request (“SR”) 224 from a user device 130, and reply to the request with a set of required amounts (“RA”) 226. The segment request 224 can include information specifying a particular segment route. The spot assessment apparatus 118 can use the particular segment route to select required amounts for that particular route, and return those required amounts in the set of required amounts 226. In some implementations, the spot assessment apparatus 118 will select required amounts for a specified time period. For example, when a calendar interface as described above with reference to FIG. 1D is used to present the required amounts, the spot assessment apparatus 118 can select the required amounts for the segment on each remaining day of the month on which a client can create the segment. In some situations, the spot assessment apparatus 118 can provide additional required amounts in the set of required amounts 226 in order to reduce the latency in presenting additional required amounts (e.g., if the client transitions to the following month in the application). In some situations, the spot assessment apparatus 118 can wait to provide those additional required amounts in response to a subsequent segment request, which can be triggered, for example, by the client transitioning to the next month in the application.

FIG. 3 is a block diagram of an example data flow 300 for dynamically optimizing segment access over time. In some implementations, segment access can be optimized (e.g., improved) by regularly updating the required amount for spots on the various segments and/or providing up to date spot availability information when a client requests information about segments through the application.

The data flow 300 can begin with the spot assessment apparatus 118 obtaining a set of segment attributes (SA) 302. The set of segment attributes 302 can be obtained, for example, from an attributes data storage unit 304. The attributes data storage unit 304 can include a set of segment attributes for each existing segment among multiple different existing segments. In some implementations, the attributes data storage unit 304 can be the same as the attributes data storage unit 206 or a different attributes data storage unit.

The attributes data storage unit 304 stores attributes of various different existing segments. For example, for each segment (e.g., S1-Sn), the attributes data storage unit 304 can store a segment capacity value. The segment capacity value for each segment specifies how many total spots are on the jet (e.g., a maximum passenger capacity). For example, if a jet has 7 total passenger seats, the segment capacity value for that jet can be set to 7.

The attributes data storage unit 304 can also store a segment type (ST) for each segment. The segment type can specify, for example, at type of jet that is being used for the segment and/or information about special services provided by the segment. In some implementations, the segment type could be set to VIP when fewer than all of the spots on the jet will be made available to clients. For example, assume that the jet has a total of 7 passenger seats, but only 5 of the seats will be made available to clients. In this example, the segment type can identify the segment as a VIP segment based on the fact that all of the seats will not be made available to clients.

The attributes data storage unit 304 can also store route information for each segment. The route information can be specified using a route code that uniquely identifies a particular segment route, or using origin port and destination port designations, as discussed above with reference to FIG. 2. For purposes of example, the route information is being presented using the origin port (OP) and destination port (DP) designations. More specifically, each unique pair of OP and DP can represent a different route.

The attributes data storage unit 304 can also include a departure time (DT) for each segment. The departure time can specify, for example, a date and/or time of departure for the segment. For example, if a segment is scheduled to depart on Mar. 4, 2018, the departure time can specify Mar. 4, 2018. The departure time can also specify a time of departure for the segment. For example, if the segment from the example above was departing a 1 PM Eastern on March 4^{th}, this information can also be specified by the departure time entry in the attributes data storage unit 304.

The spot assessment apparatus 118 obtains segment context data for each of the segments. For example, the spot assessment apparatus 118 can query a context data storage unit 306 to obtain a set of context data for the segments. More specifically, the spot assessment apparatus 118 can generate a context query 310 and submit that query to the context data storage unit 306. The context query 310 can specify one or more segments for which the spot assessment apparatus 118 is obtaining the segment context data. For example, the context query can include segment identifiers for one or more of the segments for which the set of segment attributes 302 were obtained.

The context query 310 can return a set of segment context data (CD) 312 to the spot assessment apparatus 118. The set of segment context data 312 can include information about various factors that affect the required amount for segments. For example, for each particular segment, the set of segment context data 312 can specify a claimed spots indicator (e.g., CS1-CSa). The claimed spots indicator for a specific segment can specify how many spots have been claimed on that specific segment. For example, assume that 3 spots have been claimed on a specific segment. In this example, the claimed spots indicator for that segment can have a value of 3 representing the number of spots that have been claimed on that segment.

The set of segment context data 312 can also specify an existing required amount (ERA) for each of the segments. The existing required amount specifies the current per-spot required amount for spots that remain available on the segment. In some implementations, the existing required amount can initially be generated when a segment is created, as discussed above with reference to FIG. 2. The existing required amount can also be a previously adjusted required amount (e.g., one or more adjustments to the initial required amount). In either case, the existing required amount is the required amount that can be adjusted and/or updated based on the set of segment context data 312.

The set of segment context data 312 can also include a list factor (LF) for each segment. The list factor for a specific segment is a value indicative of how many clients have placed that specific route on a segment list in the application. Generally speaking, when a client places a segment in a segment list, the client is expressing an interest in that segment. As such, client interest in a specific segment is generally considered to increase as more clients place that specific segment in their segment list. A client can place a specific segment on their segment list, for example, by interacting with a segment list element corresponding to that specific segment within the application (e.g., thereby adding the segment to a “wish list”). In some implementations, clients will also get notifications (e.g., push notifications) about that specific segment after they place that specific segment in their segment list. For example, the segment management system 110 of FIG. 1A can send out a push notification to those clients that have added a specific segment to their segment list when that specific segment is reaching capacity (e.g., when fewer than a specified number or portion of the spots remain available).

The spot assessment apparatus 118 adjusts the existing required amount for each specific segment based on the set of segment context data 312 for the specific segment and the set of segment attributes 302. In some implementations, the spot assessment apparatus 118 adjusts the existing required amount for a specific segment using an adjustment model for the specific segment. The adjustment model can specify various effects that different contextual data have on the existing required amount. The spot assessment apparatus 118 can obtain and/or access the adjustment model for the specific segment, for example, by generating a model query (MQ) 314 that specifies the specific segment.

The spot assessment apparatus 118 can use the model query 314 to obtain the adjustment model from a model data storage unit 316. The model data storage unit 316 can store various different models that have been created for various different segments. The model query 314 can be used to locate the requested model (RM) 318 in the model data storage unit 316. The spot assessment apparatus 118 can apply the model to the set of segment attributes 302 and the set of segment context data 312 to adjust the existing required amount for spots on the specific segment, as discussed in more detail below. The models can be pre-specified or continually trained and/or updated (e.g., using machine learning techniques and newly acquired historical and segment context data).

In some implementations, the adjustment model for a specific segment (or set of segments) can specify how to adjust the required amount in certain contexts. The adjustment model can include an available spots factor (avail factor) that can be used to adjust the required amount based on how many spots remain available on the segment. In some implementations, the available spots factor can be higher (e.g., leading to higher adjustments to the existing required amount) as the number of spots available decreases. The graph 320 shows an example of how the available spots factor can change based on how many available spots remain on the specific segment (or along the specific route). As shown in the graph 320, the example available spots factor increases as the number of available spots decreases.

The spot assessment apparatus 118 can use the claimed spots indicator from the set of contextual data 312 and the segment capacity from the set of segment attributes 302 to determine the number of available spots that remain on the segment. For example, the spot assessment apparatus 118 can subtract the value of the claimed spots indicator from the segment capacity to obtain the number of available spots that remain on the segment. Then the spot assessment apparatus 118 can identify the location on the graph 320 corresponding to the number of available spots that remain on the segment and read out the available spots factor at the point on the graph that corresponds to the number of available spots. The spot assessment apparatus 118 can then adjust the existing required amount based on the identified available spots factor (e.g., by multiplying or adding the available spots factor with the existing required amount). In some implementations, the available spots factor can be determined on a per-segment basis (e.g., only considering the number of available spots that remain on a specific segment. In some implementations, the available spots factor can be determined based on a per-route basis (e.g., based on a total number of available spots that remain on multiple different segments that operate over a same route) or another appropriate basis (e.g., a set of segments that operate over the same route and depart within a specified amount of time).

The adjustment model can include a time factor that is used to adjust the required amount based on how much time remains until the segment departs. In some implementations, the time factor will vary as the amount of time remaining until segment departure changes. For example, as shown in the graph 322, the time factor can initially increases as the time until segment departure decreases, but can then begin to decrease when the time to departure continues to decrease. The spot assessment apparatus 118 can use the current time (e.g., the date and/or time) and the departure time information from the set of segment attributes 302 to determine the time until segment departure. For example, the spot assessment apparatus 118 can determine a number of days and/or hours until the segment departure by comparing the departure time information from the set of segment attributes 302 and the current time. The spot assessment apparatus 118 can then use the determined time until departure to find the corresponding time factor for that time until departure (e.g., using the graph 322). The spot assessment apparatus 118 can then adjust the required amount using the identified time factor (e.g., by multiplying, dividing, adding, subtracting, or otherwise combining the identified time factor with the existing required amount).

The adjustment model can include a multi-spot factor that can be used to implement a volume-based adjustment to the required amount. In some implementations, the multi-spot factor can lower the required amount when a single client is claiming multiple spots on a specific segment. As shown in the graph 324, the multi-spot factor can generally increase as the number of spots claimed by a single client increases. In some implementations, the spot assessment apparatus 118 can combine the multi-spot factor with the existing required amount in a way that causes the required amount to decrease in proportion to the total number of spots being claimed by the single client. For example, the spot assessment apparatus 118 can subtract the multi-spot factor from the required amount or divide the required amount by the multi-spot factor. Other ways of decreasing the required amount in proportion to the number of spots being claimed can also be used. Additionally, the spot assessment apparatus 118 can use other factors to adjust the required amount based on current context data.

The spot assessment apparatus 118 can receive a segment information request (“SIR”) 326 from a user device 130, and reply to the request with a set of required amounts (“RA”) 328. The segment information request 326 can include information specifying a particular segment route and date. The spot assessment apparatus 118 can use the particular segment route and date to select the current required amounts (e.g., as adjusted above) for segments operating over that route and on that date, and return those required amounts in the set of required amounts 328.

For example, when a calendar interface as described above with reference to FIG. 1C is used to present information about existing segments, the request 326 can correspond to the user selection of a date from the calendar interface of FIG. 1C. In this example, the spot assessment apparatus 118 can select the required amounts for segments that are scheduled on that selected date, and present that information in one or more jet info cards similar to that presented in FIG. 1E. In some situations, the spot assessment apparatus 118 can provide additional required amounts in the set of required amounts 328 in order to reduce the latency in presenting additional required amounts (e.g., if the client transitions to the following month in the application). In some situations, the spot assessment apparatus 118 can wait to provide those additional required amounts in response to a subsequent segment information request, which can be triggered, for example, by the client tapping on another date from the calendar interface shown in FIG. 1C.

FIG. 4 is a flow chart of an example process 400 for dynamically optimizing segment access over time. In some implementations, access to segments is optimized by dynamically updating required amounts for spots on segments over time. Operations of the process 400 can be performed, for example, by one or more data processing apparatus, such as the segment management system 110 of FIG. 1A. Operations of the process 400 can also be implemented as instructions stored on a non-transitory computer readable medium. The instructions, when executed, cause one or more data processing apparatus to perform operations of the process 400.

A set of segment attributes are identified for each specific segment among multiple of different segments (402). The segment attributes for each specific segment include a route of the specific segment and a departure time for the specific segment. The departure time can be specified only by date or can also specify the time of day (e.g., hour and minute) at which the segment is scheduled to depart.

Each of the operations included in the box 450 can be performed for each specific segment among the multiple different segments. However, the description that follows will refer to a single specific segment for clarity.

Capacity data are obtained for the specific segment and matching segments that differ from the specific segment (404). In some implementations, the capacity data include a first segment capacity specifying how many spots remain on the specific segment. For example, the first segment capacity for a specific segment (e.g., at a particular day/time) between Fort Lauderdale, Fla. and Atlanta, Ga. can specify how many spots on that specific segment have been claimed.

The first segment capacity can be expressed in terms of a number of claimed spots relative to a total number of spots that are provided on the segment. The first segment capacity can also be expressed as a number of remaining spots (e.g., how many spots remain available on the segment). Generally speaking, the required amount for spots on the specific segment can be increased as the first segment capacity decreases and decreased as the first segment capacity increases.

The capacity data can also include a second segment capacity specifying how many spots remain on matching segments that differ from the specific segment. In some implementations the second segment capacity specifies a total number of spots remaining on all segments that operate over a same route within a specified amount of time. For example, the second segment capacity for segments that operate between Fort Lauderdale, Fla. and Atlanta, Ga. can specify the total number of spots remaining on all segments that operate over this route. In some implementations, the second segment capacity can be time limited to those segments that depart within a specified number of hours, number of days, or another appropriate period of time of the specific segment for which the required amount is being updated.

Continuing with the example above, assume that the second segment capacity specifies how many spots remain on matching segments and depart within 24 hours of the specific segment for which the existing required amount is been adjusted. In this example, the second segment capacity can be determined, for example, by identifying each segment that departs from Fort Lauderdale, Fla. to Atlanta, Ga. within 24 hours of the specific segment for which the existing required amount is being adjusted. For each identified segment, a number of remaining available spots can be determined based on the difference between the total number of spots provided on the identified segment and a total number of claimed spots on the identified segment. The number of remaining available spots for each of the identified segments can be summed to determine the second segment capacity that can be used for purposes of adjusting the required amount for spots on the specific segment being considered. Generally speaking, the required amount for spots on the specific segment can be increased as the second segment capacity decreases, and decreased as the second segment capacity increases.

An existing required amount for the spots that remain on the specific segment are obtained (406). In some implementations, the existing required amount is obtained from a data storage unit. For example, as discussed above with reference to FIG. 3, the spot assessment apparatus 118 can obtain the existing required amount for the specific segment from the context data storage unit 306. The existing required amount can specify, for example, a previous required amount that has been determined for spots on the specific segment. For example, the existing required amount can be an initial amount that was determined for spots when the segment was created (e.g., either by the service provider or a client) or an amount determined through one or more adjustments to the initial amount that was determined for spots when the segment was created.

An amount of time remaining until the departure time for the specific segment is determined (408). In some implementations, the amount of time remaining until the departure time for the specific segment is determined using the current time (e.g., the date and/or time) and the departure time information (e.g., obtained from the set of segment attributes 302). For example, a number of days and/or hours until the segment departs can be determined by comparing the departure time information and the current time.

The existing required amount for the spots that remain on the specific segment is adjusted (410). In some implementations, the existing required amount for the spots that remain on the specific segment is adjusted based on the amount of time remaining until the departure time for the specific segment, first segment capacity for the specific segment, and the second segment capacity for the matching segments.

The existing required amount can be adjusted using one or more models (e.g., one or more adjustment models) that specify rules for how various factors (e.g., context data) affect the required amount for spots on the specific segment. In some implementations, one or more models can specify rules for adjusting the existing required amount based on the amount of time remaining until the departure time for the specific segment. As discussed above with reference to FIG. 3, the existing required amount can be adjusted using the time factor specified by a model. For example, the existing required amount can be adjusted using a corresponding time factor for the amount of time remaining until the departure of the specific segment. The adjustment can be performed, for example, by multiplying, dividing, adding, subtracting, or otherwise combining the corresponding time factor with the existing required amount.

In some implementations, the model that provides the time factors can be created based on historical data for matching segments (e.g., segments having one or more same attributes as the specific segment). For example, the historical data may reveal that client interest in the matching segments peaks at a given amount of time prior to the departure time, such that the time factor may be highest at that given amount of time prior to the departure time. The historical data may also reveal that the client interest in the matching segments generally declines at various other amounts of time prior to the departure time. In this example, the model can specify different time factors for these different various amounts of time based on the differences between the client interest and/or other factors.

The existing required amount can also be adjusted based on the first segment capacity for the specific segment and/or the second segment capacity for the matching segments. For example, as discussed above with reference to FIG. 3, an adjustment model can specify various available spots factors that can be used to adjust the existing required amount based on how we spots remain available on the specific segment and/or other matching segments differ from the specific segment. In some implementations, the available spots factor can be higher (e.g., leading to higher adjustments to the existing required amount) as the number of spots available decreases. The graph 320 of FIG. 3 shows an example of how the available spots factor can change based on how many available spots remain on the specific segment (or along the specific route).

The existing required amount can be adjusted based on the available spots factor corresponding to the current number of available spots that remain on specific segment or over a particular route (e.g., by multiplying or adding the available spots factor with the existing required amount). As discussed above, the available spots factor can be determined on a per-segment basis (e.g., only considering the number of available spots that remain on a specific segment. In some implementations, the available spots factor can be determined based on a per-route basis (e.g., based on a total number of available spots that remain on multiple different segments that operate over a same route) or another appropriate basis (e.g., a set of segments that operate over the same route and depart within a specified amount of time). Generally speaking, when the available spots factor is determined on a per-route basis, the existing required amount will be adjusted based on both of the first segment capacity and the second segment capacity. Meanwhile, when the available spots factors determine on a per-segment basis, the existing required amount may be adjusted based on the first segment capacity but not the second segment capacity.

In some implementations, the existing required amount for the available spots that remain on the specific segment can be adjusted using a list factor. The list factor is a value corresponding to how many clients have interacted with a segment list element presented for the specific segment in the native application. As discussed above, generally the list factor is going to increase as the number of clients that have interacted with a segment list element presented for the specific segment increases. In some implementations, the list factor can be increased as the number of clients that interact with a segment list element presented for a matching segment increases. For example, the list factor for a specific segment can be increased as the number of clients that interact with a segment list element is presented for a different segment that operates between the same cities as the specific segment. In some implementations, matching segments that are used to determine the best factor for the specific segment can be limited to those matching segments having a departure time that is within a specified amount of time of the departure time of the specific segment.

Multiple different required amounts for the specific segment are generated based on the adjusted existing required amount and a set of tier factors for multiple different tiers (412). As discussed above, the service provider may allow for multiple different client levels or different client tiers, and multiple different required amounts for the same segment on a per-client-tier basis. Clients may be able to attain different tier levels in a variety of ways. For example, clients may be able to attain a higher tier level by paying a fee, claiming a minimum number of seats on client-initiated segments over a given time period, referring a specified number of others that become clients, or engaging in some other appropriate activity. The service provider may provide incentives for clients to attain these higher client tiers by varying the required amounts for segments based on client level. As such, multiple different required amounts can be generated for the same segment by applying different tier factors. For example, a different required amount can be generated for each different tier level by applying the tier factor for that client tier to the required amount to create per-client-tier required amounts. Generally, the tier factor for higher client tiers will result in a lower required amount than the tier factor for a lower client tiers.

In some implementations, the multiple different required amounts generated for the spots on the specific segment includes a required amount of zero for a first available spot that is claimable by clients on the specific segment. For example, assume that the lowest client tier is provided the opportunity to claim a first spot (e.g., a single seat) on the specific segment as a benefit of being a client. In this example, the multiple different required amounts would include a required amount of zero for the first spot. In some implementations, a client may be limited to only a single spot at the required amount of zero. In these implementations, another one of the multiple different required amounts would be a non-zero required amount. This non-zero required amount can be generated for one or more additional spots (e.g., beyond the first spot) that are claimable by clients on the specific segment.

In some implementations, the multiple different required amounts generated for spots on the specific segment can include a conditional required amount. The conditional required amount can be a required amount that the client must submit in addition to some other submission. For example, in situations where clients are provided internal credits (e.g., renewable tokens or other forms of credits), the conditional required amount can be an amount that applies when the client also has internal credits that can be used for the specific segment. In this example, the client would be required to submit some amount of the internal credits to meet the condition for claiming a spot at the conditional required amount.

Additional multiple different required amounts for the specific segment can also be generated. For example, one or more multi-spot required amounts that apply when a single client claims multiple spots on the specific segment can be generated. These multi-spot required amounts can be generated, for example, by applying a multi-spot factor to the required amount, as discussed above with reference to FIG. 3.

In another example, the multiple different required amounts that are generated can include a sub-capacity required amount. A sub-capacity required amount refers to a required amount that applies when the service provider restricts access to one or more available spots on the specific segment. For example, the sub-capacity required amount can be an amount that a client must submit in order to prevent all of the spots from being claimed by other clients. For example, assume that a jet has 7 total seats and that a client wants four of those total seats to remain unoccupied during a specific segment. In this example, the sub-capacity amount for this segment can be generated based on how many of the available spots on the specific segment are required to remain unclaimed at departure. More specifically, a sub-capacity factor corresponding to the number of available spots that will remain unclaimed can be combined with (e.g., multiplied with, added to, or otherwise used increase) the required amount to generate the sub-capacity required amount for the specific segment.

All of the multiple different required amounts that are generated can be stored, for example, in a data storage unit. Storing the multiple different required amounts in the data storage unit can make these different required amounts available for presentation to clients in response to a request for information about the specific segment.

The adjustment model that is used to generate the different required amounts is universal in nature, such that the same model can be used to generate the different required amounts for the different tiers. Furthermore, the adjustment model is customizable so that the adjustment model can support special circumstances. For example, the model can include an override feature that enables the service provider to apply various additional and/or different factors or otherwise change the required amount. For example, the override feature can be invoked to implement special reductions to the required amount (e.g., based on a reduction factor input by the service provider). This special reduction can be applied for a single tier level or across all tier levels. The special reduction amount can also have a specified validity period, which can invoke a timer that is set to the specified validity period. When the timer ends (e.g., reaches an end of the specified validity period), the special reduction amount can expire (e.g., by being automatically disabled by the system or having a valid flag cleared). When the special reduction amount expires, the required amounts determined by the adjustment model automatically become active again, and presented in the native application.

In some implementations, the adjustment model can also include a mechanism that enables the system to reduce the required amount using segment credits that have been accumulated by the client. For example, when a client initiates a segment or attains a higher tier level, the client may accumulate credits that can be applied to the required amount for a future segment. When generating the required amount for this client, the spot assessment engine can access a profile of the client and search for any existing segment credits that have been accumulated by the client. When the spot assessment engine detects the existence of segment credits in the client's profile, the spot assessment engine can reduce the required amount for a given segment based on the level of segment credits. For example, the required amount for the given segment can be reduced by the full amount of available credits, or some portion thereof. In some situations, the amount of segment credits that are capable of being applied to a single segment can be limited by the spot assessment engine so that a pre-specified maximum credit is not exceeded for any single segment.

Interaction with a native application is detected (414). In some implementation, the interaction corresponds to a request for information about a given specific segment among the plurality of different segments. For example, the interaction can be a user tap of a calendar interface that shows available segments, as discussed above with reference to FIG. 1C.

A given tier of a client that performed the interaction is determined (416). In some implementations, but given tier of the client can be determined by accessing a client profile that specifies the given tier of the client. For example, a client identifier that is received with data representing the interaction with the native application can be used to identify the client profile in a data storage unit. In turn, the given tier of the client can be extracted from and/or determined from the identified client profile.

A user interface of the native application is updated in response to the interaction (418). In some implementations, the user interface is updated to include a specific required amount that was generated based on the tier factor for the given tier of the client. For example, the specific required amount can be presented in a user interface similar to that presented in FIG. 1E.

Interaction with a spot claim element is detected (420). In some implementations the spot claim element with which the interaction occurs is presented in conjunction with the specific required amount by the native application that is executed at a device of the client. The interaction with the spot claim element can trigger allocation of a spot on the given specific segment to the client. For example, in response to detecting the interaction with the spot claim element presented in conjunction with the specific required amount, a spot on the given specific segment can be assigned to the client. In some implementations, the spot claim element is a purchase button or another user interface element that triggers completion of the transaction that results in a spot being claimed by a client.

The capacity data is updated following the interaction with the spot claim element (422). In some implementations, the capacity data is updated by removing the spot on the given specific segment that was assigned to the client from the first segment capacity for the given specific segment. Once the first segment capacity for the given specific segment has been updated, this information can be used to update the specific required amount for any available spots remaining on the given specific segment (404). For example, the operations discussed above can be performed again to update the required amounts for available spots based on the change in the number of spots remaining on the specific segment and/or other factors discussed above. The updated first segment capacity can also be used to update the required amounts for available spots on other segments (e.g., matching segments).

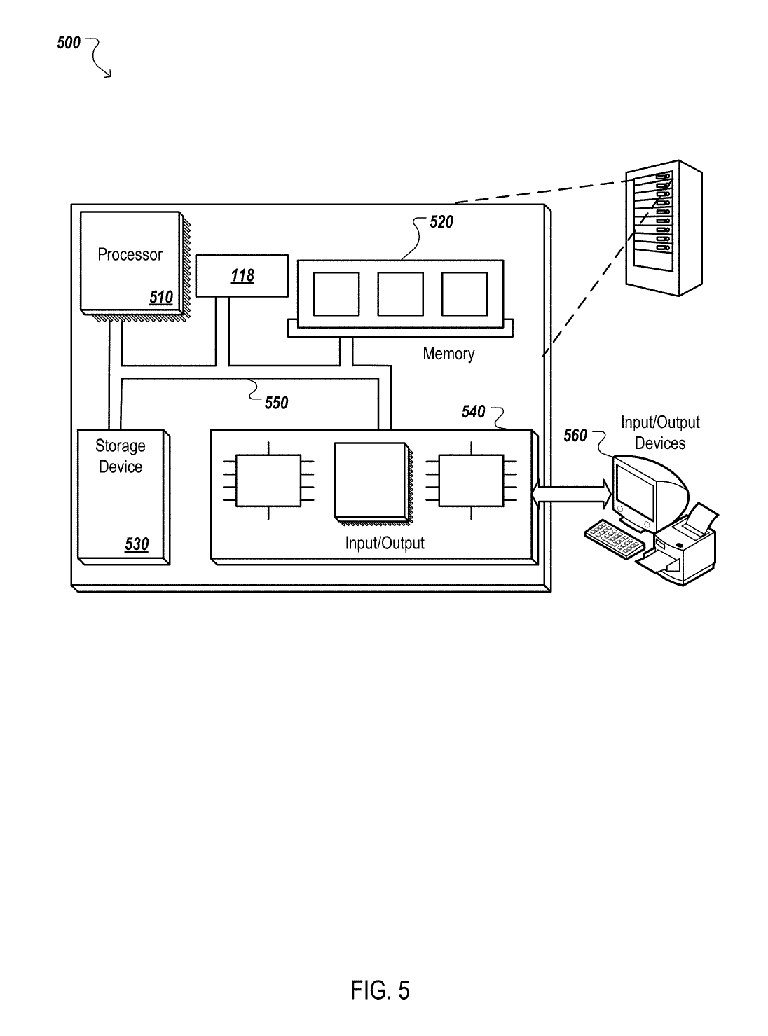

FIG. 5 is block diagram of an example computer system 500 that can be used to perform operations described above. The system 500 includes a processor 510, a memory 520, a storage device 530, an input/output device 540, and 118 as described in detail above. Each of the components 118, 510, 520, 530, and 540 can be interconnected, for example, using a system bus 550. The spot assessment apparatus 118 is shown as connected to 510, 520, 530, and 540, but could also be implemented across two or more of these components.

The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, a storage device that is shared over a network by multiple computing devices (e.g., a cloud storage device), or some other large capacity storage device.

The input/output device 540 provides input/output operations for the system 500. In one implementation, the input/output device 540 can include one or more of a network interface device, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 560. Other implementations, however, can also be used, such as mobile computing devices, mobile communication devices, set-top box television client devices, etc.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system, comprising:
one or more front-end servers that interact, over a data communication network with a native application operating at a client device; and
one or more back-end servers in data communication with the one or more front-end servers and that include one or more data processors, the one or more front-end servers or the one or more back-end servers being configured to perform operations comprising:
identifying, for each specific segment among a plurality of different segments, a set of segment attributes that include a route of the specific segment and a departure time for the specific segment;
for each specific segment among the plurality of different segments:
obtaining, from a data storage unit, capacity data including a first segment capacity specifying how many spots remain on the specific segment and a second segment capacity specifying how many spots remain on matching segments that differ from the specific segment;
obtaining, from the data storage unit, an existing required amount for the spots that remain on the specific segment;
determining, by a spot assessment apparatus, an amount of time remaining until the departure time for the specific segment;
adjusting, by the spot assessment apparatus, the existing required amount for the spots that remain on the specific segment based on the amount of time remaining until the departure time for the specific segment, first segment capacity for the specific segment, and the second segment capacity for the matching segments; and
generating multiple different required amounts for the specific segment based on the adjusted existing required amount and a set of tier factors for multiple different tiers;
detecting interaction with a native application that corresponds to a request for information about a given specific segment among the plurality of different segments:
determining a given tier of a client that performed the interaction; and
updating a user interface of the native application to include a specific required amount that was generated based on the tier factor for the given tier of the client.

2. The system of claim 1, wherein the one or more front-end servers or the one or more back-end servers are configured to perform operations comprising:
detecting interaction with a spot claim element that is presented in conjunction with the specific required amount by the native application that is executed at a device of the client;
in response to detecting the interaction with the spot claim element presented in conjunction with the specific required amount:
assigning a spot on the given specific segment to the client; and
removing the spot on the given specific segment from the first segment capacity for the given specific segment.

3. The system of claim 2, wherein the one or more front-end servers or the one or more back-end servers are configured to perform operations comprising updating the specific required amount for any available spots remaining on the given specific segment after removing the spot on the given specific segment from the first segment capacity.

4. The system of claim 1, wherein adjusting the existing required amount for the available spots that remain on the specific segment further comprises adjusting the existing required amount based on a list factor corresponding to how many clients have interacted with a segment list element presented for the specific segment in the native application.

5. The system of claim 1, wherein generating multiple different required amounts for the specific segment comprises generating, for all of the multiple different tiers, a required amount of zero for a first available spot that is claimable by clients on the specific segment.

6. The system of claim 5, wherein generating multiple different required amounts for the specific segment further comprises generating a non-zero required amount for one or more additional spots that are claimable by clients on the specific segment.

7. The system of claim 1, wherein generating multiple different required amounts for the specific segment further comprises generating one or more multi-spot required amounts that apply when a single client claims multiple spots on the specific segment.

8. The system of claim 1, wherein generating multiple different required amounts for the specific segment further comprises generating a sub-capacity required amount based on how many of the available spots on the specific segment are required to remain unclaimed at departure.

9. A method for enabling a client to claim a spot on an existing segment, comprising:
identifying, for each specific segment among a plurality of different segments, a set of segment attributes that include a route of the specific segment and a departure time for the specific segment;
for each specific segment among the plurality of different segments:
obtaining, from a data storage unit, capacity data including a first segment capacity specifying how many spots remain on the specific segment and a second segment capacity specifying how many spots remain on matching segments that differ from the specific segment;
obtaining, from the data storage unit, an existing required amount for the spots that remain on the specific segment;
determining, by a spot assessment apparatus, an amount of time remaining until the departure time for the specific segment;
adjusting, by the spot assessment apparatus, the existing required amount for the spots that remain on the specific segment based on the amount of time remaining until the departure time for the specific segment, first segment capacity for the specific segment, and the second segment capacity for the matching segments; and
generating multiple different required amounts for the specific segment based on the adjusted existing required amount and a set of tier factors for multiple different tiers;
detecting interaction with a native application that corresponds to a request for information about a given specific segment among the plurality of different segments:
determining a given tier of a client that performed the interaction; and
updating a user interface of the native application to include a specific required amount that was generated based on the tier factor for the given tier of the client.

10. The method of claim 9, comprising:
detecting interaction with a spot claim element that is presented in conjunction with the specific required amount by the native application that is executed at a device of the client;
in response to detecting the interaction with the spot claim element presented in conjunction with the specific required amount:
assigning a spot on the given specific segment to the client; and
removing the spot on the given specific segment from the first segment capacity for the given specific segment.

11. The method of claim 10, comprising updating the specific required amount for any available spots remaining on the given specific segment after removing the spot on the given specific segment from the first segment capacity.

12. The method of claim 9, wherein adjusting the existing required amount for the available spots that remain on the specific segment further comprises adjusting the existing required amount based on a list factor corresponding to how many clients have interacted with a segment list element presented for the specific segment in the native application.

13. The method of claim 9, wherein generating multiple different required amounts for the specific segment comprises generating, for all of the multiple different tiers, a required amount of zero for a first available spot that is claimable by clients on the specific segment.

14. The method of claim 13, wherein generating multiple different required amounts for the specific segment further comprises generating a non-zero required amount for one or more additional spots that are claimable by clients on the specific segment.

15. The method of claim 9, wherein generating multiple different required amounts for the specific segment further comprises generating one or more multi-spot required amounts that apply when a single client claims multiple spots on the specific segment.

16. The method of claim 9, wherein generating multiple different required amounts for the specific segment further comprises generating a sub-capacity required amount based on how many of the available spots on the specific segment are required to remain unclaimed at departure.

17. A non-transitory computer readable medium storing instructions that when executed by one or more computing devices cause the one or more computing device to perform operations comprising:
identifying, for each specific segment among a plurality of different segments, a set of segment attributes that include a route of the specific segment and a departure time for the specific segment;
for each specific segment among the plurality of different segments:
obtaining, from a data storage unit, capacity data including a first segment capacity specifying how many spots remain on the specific segment and a second segment capacity specifying how many spots remain on matching segments that differ from the specific segment;
obtaining, from the data storage unit, an existing required amount for the spots that remain on the specific segment;
determining an amount of time remaining until the departure time for the specific segment;
adjusting the existing required amount for the spots that remain on the specific segment based on the amount of time remaining until the departure time for the specific segment, first segment capacity for the specific segment, and the second segment capacity for the matching segments; and
generating multiple different required amounts for the specific segment based on the adjusted existing required amount and a set of tier factors for multiple different tiers;
detecting interaction with a native application that corresponds to a request for information about a given specific segment among the plurality of different segments:
determining a given tier of a client that performed the interaction; and
updating a user interface of the native application to include a specific required amount that was generated based on the tier factor for the given tier of the client.

18. The computer readable medium of claim 17, wherein the instructions cause the one or more computing devices to perform operations comprising:
detecting interaction with a spot claim element that is presented in conjunction with the specific required amount by the native application that is executed at a device of the client;
in response to detecting the interaction with the spot claim element presented in conjunction with the specific required amount:
assigning a spot on the given specific segment to the client; and
removing the spot on the given specific segment from the first segment capacity for the given specific segment.

19. The computer readable medium of claim 18, comprising updating the specific required amount for any available spots remaining on the given specific segment after removing the spot on the given specific segment from the first segment capacity.

20. The computer readable medium of claim 17, wherein adjusting the existing required amount for the available spots that remain on the specific segment further comprises adjusting the existing required amount based on a list factor corresponding to how many clients have interacted with a segment list element presented for the specific segment in the native application.
